(19) United States
(12) Patent Application Publication
(10) Pub. No.: US 2002/0187232 A1
(43) Pub. Date: Dec. 12, 2002

(54) Method of improving the taste of low-calorie beverages and food products

(76) Inventors: Thomas Lee, Scarsdale, NY (US); Gino Olcese, Scarsdale, NY (US); Zena Bell, Yonkers, NY (US)

Correspondence Address: FITZPATRICK CELLA HARPER & SCINTO, 30 ROCKEFELLER PLAZA, NEW YORK, NY, 10112, US

(21) Appl. No.: 09/845,281

(22) Filed: May 1, 2001

(51) Int. Cl. A23L 1/236

(52) U.S. Cl. 426/548

(57) ABSTRACT

A blend of non-nutritive sweeteners, a sugar alcohol and D-tagatose are added to a low-calorie beverage or food product to achieve a taste substantially similar to that of a full-calorie beverage or food product.

### BACKGROUND OF THE INVENTION

1. Field of the Invention

This invention relates to a method of improving the taste of low-calorie beverages and food products. By including a blend of non-nutritive sweeteners, a sugar alcohol and D-tagatose in a low-calorie beverage or food product, a taste similar to that of a full-calorie beverage or food product is achieved. This invention also relates to beverages and food products which include the non-nutritive sweetener blend, the sugar alcohol and D-tagatose.

2. Related Background Art

Diet or low-calorie beverages and food products are very popular. Such diet products typically contain, singularly or in blends, non-nutritive sweeteners such as aspartame, acesulfame-K, saccharin, sucralose and cyclamate. While consumers do not have to worry about calories, non-nutritive sweeteners are known to impart a taste different from that of full-calorie counterparts. So-called “diet taste” is commonly described as slow onset but lingering sweetness accompanied with a bitter and/or metallic undesirable aftertaste. Due to the greatly reduced sugar solid content, diet drinks also lack the body and/or thickness perception associated with full-calorie drinks. G. R. Shore, et al., “Taste and Mouthfeel in Low Calorie Soft Drinks”, Contribution of Low- and Non-Volatile Materials to the Flavor of Foods, W. Pickenhagen, ed., Allured Publishing Corp., pp. 119-123 (1996).

Low-calorie beverages and food products with tastes similar to those of full-calorie products are very desirable and have been sought after for quite some time. Currently, however, methods of improving taste have fallen short of achieving a taste similar to full-calorie products.

One option is to blend non-nutritive sweeteners. Many blends (e.g., aspartame and acesulfame-K) impart a higher degree of sweetness than individual sweeteners on an equal concentration basis. This synergistic effect results in sparing the amount of sweetener used in a given application and is therefore referred to as quantitative synergy. Blending also causes another kind of synergy, referred to as qualitative synergy, because the taste quality of the blend often is more rounded and of less bitter/metallic off-taste.

The beverage industry has taken advantage of these synergies and marketed many diet colas containing sweetener blends. “Blending the Taste Sensation”, Liquid Foods Int'l., vol. 3, no. 1, p. 31 (1999). For example, PepsiONE® (aspartame/acesulfame-K), Coke Light® (aspartame/acesulfame-K or sodium cyclamate/acesulfame-K/aspartame) and Diet Rite Cola® (sucralose/acesulfame-K) all contain sweetener blends. Sweetener blending can also enhance the shelf-life of diet cola, especially in cases where aspartame is used as a key sweetener. For example, most soda fountain diet colas in the United States contain aspartame, acesulfame-K, and sodium saccharin. When aspartame degrades, the other two stable sweeteners maintain a certain degree of sweet taste.

Another option is to include flavor enhancing additives. A myriad of such flavor enhancing additives have been identified to date. U.S. Pat. Nos. 4,902,525 and 6,066,345, JPA 7-274829 and EP 0 759 273 relate to the addition of erythritol to beverages for purposes of flavor enhancement. Additionally, D-tagatose is known to produce improved flavor and mouthfeel at low doses with combinations of intense sweeteners.

Efforts in the beverage industry in the United States and abroad have produced taste-improved diet products. To date, however, there is simply no effective method of improving the taste of low-calorie beverages and food products, i.e., achieving a taste similar to that of full-calorie beverages and food products.

### SUMMARY OF THE INVENTION

This invention is directed to a method of improving the taste of a low-calorie beverage comprising the step of including in said low-calorie beverage (a) a blend of non-nutritive sweeteners, (b) a sugar alcohol and (c) D-tagatose. According to certain preferred embodiments of the present invention, the beverage is a soft drink such as a cola or lemon-lime soft drink, a fountain beverage, a frozen ready-to-drink beverage, a coffee beverage, a tea beverage, a powdered soft drink, a liquid concentrate, a flavored water, a fruit juice or a fruit juice flavored drink, a sport drink or an alcoholic drink.

The present invention is also directed to a method of improving the taste of a low-calorie food product comprising the step of including in said low-calorie food product (a) a blend of non-nutritive sweeteners, (b) a sugar alcohol and (c) D-tagatose. According to certain preferred embodiments of the present invention, the food product is a confection, dairy product, gelatin, pudding, cake mix or baked good.

According to certain preferred embodiments of the present invention, the non-nutritive sweeteners are selected from aspartame, acesulfame salts, saccharins, cyclamates, sucralose, alitame, neotame, steviosides, glycyrrhizin, Lo Han Guo, neohesperidin dihydrochalcone, monatin, monellin, thaumatin, and brazzein, and the sugar alcohol is selected from sorbitol, maltitol, xylitol and erythritol.

The present invention is also directed to low-calorie beverages and food products which include (a) a blend of non-nutritive sweeteners, (b) a sugar alcohol and (c) D-tagatose.

### DETAILED DESCRIPTION

The present invention is directed to a method of improving the taste of low-calorie beverages and food products. As used herein, “taste” refers to a combination of sweetness perception, temporal effects of sweetness perception, i.e., on-set and duration, off-tastes, e.g., bitterness and metallic taste, residual perception (aftertaste) and tactile perception, e.g., body and thickness. According to the present invention, it is possible to achieve a low-calorie beverage or food product with a taste that is substantially similar to that of a full-calorie beverage or food product. As a result of the present inventive method and, in particular, the combination of sweetener blend, sugar alcohol and D-tagatose, overall sweetness, aftertaste duration, mouthfeel and sucrose-like quality of low-calorie foods and beverages are unexpectedly and advantageously improved.

According to the first embodiment of the present invention, the taste of a low-calorie beverage is improved by including in the beverage (a) a blend of non-nutritive sweeteners, (b) a sugar alcohol and (c) D-tagatose. Beverages include, without limitation, carbonated soft drinks, fountain beverages, frozen ready-to-drink beverages, coffee beverages, tea beverages, powdered soft drinks, as well as liquid concentrates, flavored waters, fruit juice and fruit juice flavored drinks, sport drinks and alcoholic products. The beverage may be carbonated or noncarbonated. In a preferred embodiment of the present invention, the beverage is a carbonated cola-flavored soft drink.

While it is believed that the combination of a single non-nutritive sweetener, a sugar alcohol and D-tagatose would lead to improved taste, it is also believed that the improvement is much more pronounced when using a blend of non-nutritive sweeteners. The blend of non-nutritive sweeteners lends qualitative synergy to the taste of a low-calorie beverage in which it is included. Any blend of non-nutritive sweeteners can be employed in the present invention; two-, three-, four- and five-way blends of non-nutritive sweeteners are preferred. Non-nutritive sweeteners suitable for use in the present invention include, without limitation, aspartame, acesulfame salts such as acesulfame-K, saccharins (e.g., sodium and calcium salts), cyclamates (e.g., sodium and calcium salts), sucralose, alitame, neotame, steviosides, glycyrrhizin, Lo Han Guo, neohesperidin dihydrochalcone, monatin, and protein sweeteners such as thaumatin, monellin and brazzein.

Preferred two-way blends include aspartame/acesulfame-K, sodium saccharin/sodium cyclamate and sucralose/acesulfame-K. Preferred three-way blends include aspartame/acesulfame-K/sodium saccharin, aspartame/acesulfame-K/sucralose, aspartame/acesulfame-K/sodium cyclamate, aspartame/sodium saccharin/sucralose, sucralose/sodium saccharin/sodium cyclamate and acesulfame-K/sodium cyclamate/sucralose. Preferred four-way blends include aspartame/acesulfame-K/sodium saccharin/sodium cyclamate, acesulfame-K/sodium saccharin/sodium cyclamate/sucralose, aspartame/acesulfame-K/sodium cyclamate/sucralose and aspartame/acesulfame-K/sodium saccharin/sucralose. Preferred five-way blends include aspartame/acesulfame-K/sodium saccharin/sodium cyclamate/sucralose.

One of ordinary skill in this art will readily appreciate that non-nutritive sweeteners may be combined in various ratios to form a non-nutritive sweetener blend suitable for use in the present invention. Precise ratios of non-nutritive sweeteners depend on the combination of sweeteners used in a given blend and the desired overall sweetness for a given application. Appropriate ratios can be readily determined by one of ordinary skill in this art.

One of ordinary skill in this art will also readily appreciate that the amount of the blend of non-nutritive sweeteners in a finished beverage will vary depending on a variety of factors such as the desired overall sweetness for a given application. Appropriate amounts can be readily determined by one of ordinary skill in this art.

In addition to the non-nutritive sweetener blend, a sugar alcohol is included in a low-calorie beverage in order to improve the overall taste. The use of a sugar alcohol blocks the lingering sweetness and the bitter/metallic aftertaste associated with the use of non-nutritive sweeteners. Sugar alcohols suitable for use in the present invention include, without limitation, sorbitol, maltitol, xylitol and erythritol. Erythritol, i.e., meso-erythritol, is especially preferred for use in the present invention. Typically, erythritol is included in an amount from about 0.1% to 3.5% of the finished beverage, preferably from about 0.2% to 2.5% of the finished beverage.

D-tagatose is also included in the low-calorie beverage in order to improve the overall taste. The use of D-tagatose enhances mouthfeel (also referred to as body, thickness or delocalization of sweetness). D-tagatose is included in an amount from about 0.1% to 1.0% of the finished beverage, preferably 0.3% to 0.6% of the finished beverage.

The non-nutritive sweetener blend provides no caloric content to a low-calorie beverage. Based on the use level of both the sugar alcohol and the D-tagatose in the present invention, use of these ingredients does not have a significant impact on the total caloric content of a beverage sweetened with the low-calorie sweetener composition of the present invention. For example, erythritol, a 4-carbon sugar alcohol, which can be obtained from Cerestar (Hammond, Ind.), is reported to generate almost no calories (0.2 kCal/g). D-tagatose, which can be obtained from Arla Foods (Union, N.J.), is reported to impart about 1.5 kCal/g. It should be noted that both erythritol and D-tagatose do impart a certain degree of sweetness to the overall beverage.

Another embodiment of the present invention is directed to improving the taste of a low-calorie food product by including in the food product (a) a blend of non-nutritive sweeteners, (b) a sugar alcohol and (c) D-tagatose. Such food products include, without limitation, confections, dairy products, gelatins, puddings, cake mixes and baked goods. In a preferred embodiment of the present invention, the food product is a gelatin dessert. All of the above discussion related to the inclusion of a non-nutritive sweetener blend, sugar alcohol and D-tagatose in a low-calorie beverage is applicable to low-calorie food products.

Additional embodiments of the present invention are directed to low-calorie beverages and food products which include (a) a blend of non-nutritive sweeteners, (b) a sugar alcohol and (c) D-tagatose as set forth above.

It is possible to include any other ingredients typically used in low-calorie beverages and food products in appropriate amounts in the low-calorie beverages and food products of the present invention.

The examples which follow are intended as an illustration of certain preferred embodiments of the invention, and no limitation of the invention is implied.

### EXAMPLE 1

A 2-liter syrup for use in making a finished cola drink was prepared. The ingredients listed in Table 1 were added in sequence to approximately 1-1.5 L purified water with stirring.

TABLE 1

| ingredient | (g) |
|---|---|
| sodium benzoate | 2.04 |
| phosphoric acid | 4.41 |
| caffeine | 1.27 |
| citric acid | 1.63 |
| cola flavors | 38.63 |
| aspartame | 1.63 |
| acesulfame-K | 0.528 |
| sodium saccharin | 0.42 |
| sodium cyclamate | 4.2 |
| erythritol | 24.0 |
| D-tagatose | 48.0 |

Purified water was added until the syrup was 2 liters in volume. Then, 50 mL portions of the syrup were added respectively to 250 mL portions of carbonated water, i.e., a five-plus-one “throw”, to obtain finished cola drinks. The drinks were sealed, shaken several times and aged in a temperature-controlled (90° F.) room. Drinks were pulled at regular intervals and evaluated by a panel of experts in cola taste. Drinks made according to this example were judged as providing a taste extremely close to that of a control regular or full-calorie cola drink.

### EXAMPLE 2

A 2-liter syrup for use in making a finished cola drink was prepared. The ingredients listed in Table 2 were added in sequence to approximately 1-1.5 L purified water with stirring.

TABLE 2

| ingredient | (g) |
|---|---|
| sodium benzoate | 2.04 |
| phosphoric acid | 4.41 |
| caffeine | 1.27 |
| citric acid | 1.63 |
| cola flavors | 38.63 |
| aspartame | 2.72 |
| acesulfame-K | 0.66 |
| sodium saccharin | 0.468 |
| erythritol | 26.4 |
| D-tagatose | 52.8 |

Purified water was added until the syrup was 2 liters in volume. Then, 50 mL portions of the syrup were added respectively to 250 mL portions of carbonated water, i.e., a five-plus-one “throw”, to obtain finished cola drinks. The drinks were sealed, shaken several times and aged in a temperature-controlled (90° F.) room. Drinks were pulled at regular intervals and evaluated by a panel of experts in cola taste. Drinks made according to this example were judged as providing a taste extremely close to that of a control regular or full-calorie cola drink.

### EXAMPLE 3

A 2-liter syrup for use in making a finished cola drink was prepared. The ingredients listed in Table 3 were added in sequence to approximately 1-1.5 L purified water with stirring.

TABLE 3

| ingredient | (g) |
|---|---|
| sodium benzoate | 2.04 |
| phosphoric acid | 4.41 |
| caffeine | 1.27 |
| citric acid | 1.63 |
| cola flavors | 38.63 |
| acesulfame-K | 1.836 |
| sodium cyclamate | 4.488 |
| sodium saccharin | 0.912 |
| sucralose | 0.516 |
| erythritol | 24.0 |
| D-tagatose | 48.0 |

Purified water was added until the syrup was 2 liters in volume. Then, 50 mL portions of the syrup were added respectively to 250 mL portions of carbonated water, i.e., a five-plus-one “throw”, to obtain finished cola drinks. The drinks were sealed, shaken several times and aged at room temperature for 4 weeks. Drinks were evaluated by trained panelists. Drinks made according to this example exhibited no statistical differences as compared to a full-calorie cola with respect to sweetness, mouthfeel and cola flavor.

### EXAMPLE 4

Cola drinks were prepared in the same manner as in Example 1 except insofar as a five-way blend of aspartame/acesulfame-K/sodium saccharin/sodium cyclamate/sucralose was used. Sodium saccharin was included in an amount from 30-40 ppm, e.g., 35 ppm, in the finished cola drinks. The ratio of aspartame/acesulfame-K/sodium saccharin/sodium cyclamate/sucralose, with the amount of sodium saccharin being one, was 2.50-3.0:1.0-1.5:1:4.0-8.0:0.3-0.8. Drinks made according to this example were judged as providing a taste extremely close to that of a control regular or full-calorie cola drink.

### EXAMPLE 5

Cola drinks were prepared in the same manner as in Example 1 except insofar as a four-way blend of aspartame/acesulfame-K/sodium saccharin/sodium cyclamate was used. Sodium saccharin was included in an amount from 30-40 ppm, e.g., 35 ppm, in the finished cola drinks. The ratio of aspartame/acesulfame-K/sodium saccharin/sodium cyclamate, with the amount of sodium saccharin being one, was 3.25-4.25:1.00-1.50: 1:8-11. Drinks made according to this example were judged as providing a taste extremely close to that of a control regular or full-calorie cola drink.

### EXAMPLE 6

Cola drinks were prepared in the same manner as in Example 1 except insofar as a four-way blend of acesulfame-K/sodium saccharin/sodium cyclamate/sucralose was used. Sodium saccharin was included in an amount from 70-80 ppm, e.g., 75 ppm, in the finished cola drinks. The ratio of acesulfame-K/sodium saccharin/sodium cyclamate/sucralose, with the amount of sodium saccharin being one, was 1.5-2.5:1:4.0-6.0:0.4-0.8. Drinks made according to this example were judged as providing a taste extremely close to that of a control regular or full-calorie cola drink.

### EXAMPLE 7

Cola drinks were prepared in the same manner as in Example 1 except insofar as a four-way blend of aspartame/acesulfame-K/sodium saccharin/sucralose was used. Sodium saccharin was included in an amount from 25-45 ppm, e.g., 35 ppm, in the finished cola drinks. The ratio of aspartame/acesulfame-K/sodium saccharin/sucralose, with the amount of sodium saccharin being one, was 3.7-4.1:1.2-1.7:1:0.4-0.8. Drinks made according to this example were judged as providing a taste extremely close to that of a control regular or full-calorie cola drink.

### EXAMPLE 8

Cola drinks were prepared in the same manner as in Example 1 except insofar as a three-way blend of aspartame/acesulfame-K/sodium saccharin was used. Sodium saccharin was included in an amount from 35-45 ppm, e.g., 40 ppm, in the finished cola drinks. The ratio of aspartame/acesulfame-K/sodium saccharin, with the amount of sodium saccharin being one, was 5.25-6.05 :1.25-1.55:1. Drinks made according to this example were judged as providing a taste extremely close to that of a control regular or full-calorie cola drink.

### EXAMPLE 9

Cola drinks were prepared in the same manner as in Example 1 except insofar as a three-way blend of aspartame/acesulfame-K/sucralose was used. Sucralose was included in an amount from 45-55 ppm, e.g., 50 ppm, in the finished cola drinks. The ratio of aspartame/acesulfame-K/sucralose, with the amount of sucralose being one, was 1.8-2.8:1.2-1.5:1. Drinks made according to this example were judged as providing a taste extremely close to that of a control regular or full-calorie cola drink.

### EXAMPLE 10

Cola drinks were prepared in the same manner as in Example 1 except insofar as a three-way blend of aspartame/acesulfame-K/sodium cyclamate was used. Acesulfame-K was included in an amount from 40-70 ppm, e.g., 55 ppm, in the finished cola drinks. The ratio of aspartame/acesulfame-K/sodium cyclamate, with the amount of acesulfame-K being one, was 3.5-4.5:1:6.0-8.0. Drinks made according to this example were judged as providing a taste extremely close to that of a control regular or full-calorie cola drink.

### EXAMPLE 11

Cola drinks were prepared in the same manner as in Example 1 except insofar as a three-way blend of acesulfame-K/sodium saccharin/sucralose was used. Sodium saccharin was included in an amount from 35-75 ppm, e.g., 40 ppm, in the finished cola drinks. The ratio of acesulfame-K/sodium saccharin/sucralose, with the amount of sodium saccharin being one, was 1.0-2.5:1:1.5-2.5. Drinks made according to this example were judged as providing a taste extremely close to that of a control regular or full-calorie cola drink.

### EXAMPLE 12

Cola drinks were prepared in the same manner as in Example 1 except insofar as a three-way blend of acesulfame-K/sodium saccharin/sodium cyclamate was used. Sodium saccharin was included in an amount from 45-60 ppm, e.g., 55 ppm, in the finished cola drinks. The ratio of acesulfame-K/sodium saccharin/sodium cyclamate, with the amount of sodium saccharin being one, was 1.5-2.5:1:6.0-8.0. Drinks made according to this example were judged as providing a taste extremely close to that of a control regular or full-calorie cola drink.

### EXAMPLE 13

Cola drinks were prepared in the same manner as in Example 1 except insofar as a two-way blend of aspartame/acesulfame-K was used. Aspartame was included in an amount of about 300 ppm, while acesulfame-K was included in an amount of about 95 ppm in the finished cola drinks. Drinks made according to this example were judged as providing a taste extremely close to that of a control regular or full-calorie cola drink.

### EXAMPLE 14

Cola drinks were prepared in the same manner as in Example 1 except insofar as a two-way blend of sodium saccharin/sodium cyclamate was used. Sodium saccharin and sodium cyclamate were included in a ratio of about 1:10 in the finished cola drinks. Drinks made according to this example were judged as providing a taste extremely close to that of a control regular or full-calorie cola drink.

### EXAMPLE 15

Cola drinks were prepared in the same manner as in Example 1 except insofar as a two-way blend of sucralose/acesulfame-K was used. Sucralose was included in an amount of about 160 ppm, while acesulfame-K was included in an amount of about 122 ppm in the finished cola drinks. Drinks made according to this example were judged as providing a taste extremely close to that of a control regular or full-calorie cola drink.

### COMPARATIVE EXAMPLES 1A and 1B

Cola drinks were prepared in the same manner as in Example 1, except insofar as erythritol and D-tagatose were omitted, respectively. Drinks were evaluated by a panel of experts in cola taste. Drinks made according to these comparative examples were judged as failing to provide a taste extremely close to that of a control regular or full-calorie cola drink, i.e., the drinks exhibited “diet taste”.

### COMPARATIVE EXAMPLES 2A and 2B

Cola drinks were prepared in the same manner as in Example 2, except insofar as erythritol and D-tagatose were omitted, respectively. Drinks were evaluated by a panel of experts in cola taste. Drinks made according to these comparative examples were judged as failing to provide a taste extremely close to that of a control regular or full-calorie cola drink, i.e., the drinks exhibited “diet taste”.

### COMPARATIVE EXAMPLES 3A and 3B

Cola drinks were prepared in the same manner as in Example 3, except insofar as erythritol and D-tagatose were omitted, respectively. Drinks were evaluated by a panel of experts in cola taste. Drinks made according to these comparative examples were judged as failing to provide a taste extremely close to that of a control regular or full-calorie cola drink, i.e., the drinks exhibited “diet taste”.

Other variations and modifications of this invention will be obvious to those skilled in this art. This invention is not to be limited except as set forth in the following claims.

What is claimed is:

1. A method of improving the taste of a low-calorie beverage comprising the step of including in said low-calorie beverage (a) a blend of non-nutritive sweeteners, (b) a sugar alcohol and (c) D-tagatose.

2. The method according to claim 1, wherein the blend of non-nutritive sweeteners comprises two, three, four or five non-nutritive sweeteners.

3. The method according to claim 1, wherein the non-nutritive sweeteners are selected from the group consisting of aspartame, acesulfame salts, saccharins, cyclamates, sucralose, alitame, neotame, steviosides, glycyrrhizin, Lo Han Guo, neohesperidin dihydrochalcone, monatin, monellin, thaumatin and brazzein.

4. The method according to claim 3, wherein the blend of non-nutritive sweeteners comprises aspartame and acesulfame-K.

5. The method according to claim 3, wherein the blend of non-nutritive sweeteners comprises sodium saccharin and sodium cyclamate.

6. The method according to claim 3, wherein the blend of non-nutritive sweeteners comprises acesulfame-K and sucralose.

7. The method according to claim 3, wherein the blend of non-nutritive sweeteners comprises aspartame, acesulfame-K and sodium saccharin.

8. The method according to claim 3, wherein the blend of non-nutritive sweeteners comprises sucralose, sodium saccharin and sodium cyclamate.

9. The method according to claim 3, wherein the blend of non-nutritive sweeteners comprises acesulfame-K, sodium cyclamate and sucralose.

10. The method according to claim 3, wherein the blend of non-nutritive sweeteners comprises aspartame, acesulfame-K and sucralose.

11. The method according to claim 3, wherein the blend of non-nutritive sweeteners comprises aspartame, acesulfame-K and sodium cyclamate.

12. The method according to claim 3, wherein the blend of non-nutritive sweeteners comprises aspartame, sodium saccharin and sucralose.

13. The method according to claim 3, wherein the blend of non-nutritive sweeteners comprises aspartame, acesulfame-K, sodium saccharin and sodium cyclamate.

14. The method according to claim 3, wherein the blend of non-nutritive sweeteners comprises aspartame, acesulfame-K, sodium saccharin and sucralose.

15. The method according to claim 3, wherein the blend of non-nutritive sweeteners comprises acesulfame-K, sodium saccharin, sodium cyclamate and sucralose.

16. The method according to claim 3, wherein the blend of non-nutritive sweeteners comprises aspartame, acesulfame-K, sodium cyclamate and sucralose.

17. The method according to claim 3, wherein the blend of non-nutritive sweeteners comprises aspartame, acesulfame-K, sodium saccharin, sodium cyclamate and sucralose.

18. The method according to claim 1, wherein the sugar alcohol is selected from the group consisting of sorbitol, maltitol, xylitol and erythritol.

19. The method according to claim 18, wherein the sugar alcohol is erythritol.

20. The method according to claim 19, wherein the erythritol is present in an amount of 0.1% to about 3.5% based on finished low-calorie beverage weight.

21. The method according to claim 20, wherein the sugar alcohol is present in an amount of about 0.2% to about 2.5% based on finished low-calorie beverage weight.

22. The method according to claim 1, wherein the D-tagatose is present in an amount of about 0.1% to about 1.0% based on finished low-calorie beverage weight.

23. The method according to claim 22, wherein the D-tagatose is present in an amount of about 0.3% to about 0.6% based on finished low-calorie beverage weight.

24. The method according to claim 1, wherein said beverage is selected from the group consisting of soft drinks, fountain beverages, frozen ready-to-drink beverages, coffee beverages, tea beverages, powdered soft drinks, liquid concentrates, flavored waters, fruit juice and fruit juice flavored drinks, sport drinks and alcoholic drinks.

25. The method according to claim 24, wherein said beverage is a soft drink selected from the group consisting of cola and lemon-lime soft drinks.

26. A low-calorie beverage comprising (a) a blend of non-nutritive sweeteners, (b) a sugar alcohol and (c) D-tagatose.

27. The low-calorie beverage according to claim 26, wherein the blend of non-nutritive sweeteners comprises two, three, four or five non-nutritive sweeteners.

28. The low-calorie beverage according to claim 26, wherein the non-nutritive sweeteners are selected from the group consisting of aspartame, acesulfame salts, saccharins, cyclamates, sucralose, alitame, neotame, steviosides, glycyrrhizin, Lo Han Guo, neohesperidin dihydrochalcone, monatin, monellin, thaumatin and brazzein.

29. The low-calorie beverage according to claim 28, wherein the blend of non-nutritive sweeteners comprises aspartame and acesulfame-K.

30. The low-calorie beverage according to claim 28, wherein the blend of non-nutritive sweeteners comprises sodium saccharin and sodium cyclamate.

31. The low-calorie beverage according to claim 28, wherein the blend of non-nutritive sweeteners comprises acesulfame-K and sucralose.

32. The low-calorie beverage according to claim 28, wherein the blend of non-nutritive sweeteners comprises aspartame, acesulfame-K and sodium saccharin.

33. The low-calorie beverage according to claim 28, wherein the blend of non-nutritive sweeteners comprises sucralose, sodium saccharin and sodium cyclamate.

34. The low-calorie beverage according to claim 28, wherein the blend of non-nutritive sweeteners comprises acesulfame-K, sodium cyclamate and sucralose.

35. The low-calorie beverage according to claim 28, wherein the blend of non-nutritive sweeteners comprises aspartame, acesulfame-K and sucralose.

36. The low-calorie beverage according to claim 28, wherein the blend of non-nutritive sweeteners comprises aspartame, acesulfame-K and sodium cyclamate.

37. The low-calorie beverage according to claim 28, wherein the blend of non-nutritive sweeteners comprises aspartame, sodium saccharin and sucralose.

38. The low-calorie beverage according to claim 28, wherein the blend of non-nutritive sweeteners comprises aspartame, acesulfame-K, sodium saccharin and sodium cyclamate.

39. The low-calorie beverage according to claim 28, wherein the blend of non-nutritive sweeteners comprises aspartame, acesulfame-K, sodium saccharin and sucralose.

40. The low-calorie beverage according to claim 28, wherein the blend of non-nutritive sweeteners comprises acesulfame-K, sodium saccharin, sodium cyclamate and sucralose.

41. The low-calorie beverage according to claim 28, wherein the blend of non-nutritive sweeteners comprises aspartame, acesulfame-K, sodium cyclamate and sucralose.

42. The low-calorie beverage according to claim 28, wherein the blend of non-nutritive sweeteners comprises aspartame, acesulfame-K, sodium saccharin, sodium cyclamate and sucralose.

43. The low-calorie beverage according to claim 26, wherein the sugar alcohol is selected from the group consisting of sorbitol, maltitol, xylitol and erythritol.

44. The low-calorie beverage according to claim 43, wherein the sugar alcohol is erythritol.

45. The low-calorie beverage according to claim 44, wherein the erythritol is present in an amount of 0.1% to about 3.5% based on finished low-calorie beverage weight.

46. The low-calorie beverage according to claim 45, wherein the sugar alcohol is present in an amount of about 0.2% to about 2.5% based on finished low-calorie beverage weight.

47. The low-calorie beverage according to claim 26, wherein the D-tagatose is present in an amount of about 0.1% to about 1.0% based on finished low-calorie beverage weight.

48. The low-calorie beverage according to claim 47, wherein the D-tagatose is present in an amount of about 0.3% to about 0.6% based on finished low-calorie beverage weight.

49. The low-calorie beverage according to claim 26, wherein said beverage is selected from the group consisting of soft drinks, fountain beverages, frozen ready-to-drink beverages, coffee beverages, tea beverages, powdered soft drinks, liquid concentrates, flavored waters, fruit juice and fruit juice flavored drinks, sport drinks and alcoholic drinks.

50. The low-calorie beverage according to claim 49, wherein said beverage is a soft drink selected from the group consisting of cola and lemon-lime soft drinks.

51. A method of improving the taste of a low-calorie food product comprising the step of including in said low-calorie food product (a) a blend of non-nutritive sweeteners, (b) a sugar alcohol and (c) D-tagatose.

52. The method according to claim 51, wherein the food product is selected from the group consisting of confections, dairy products, gelatins, puddings, cake mixes and baked goods.

53. A low-calorie food product comprising (a) a blend of non-nutritive sweeteners, (b) a sugar alcohol and (c) D-tagatose.
